(19) United States
(12) Patent Application Publication
(10) Pub. No.: US 2002/0071483 A1
(43) Pub. Date: Jun. 13, 2002

(54) Reception of data in DSL modems

(76) Inventors: Sandeep Oswal, Bangalore (IN); Prakash Easwaran, Bangalore (IN); Krishnan Ramabadran, Bangalore (IN); Murtaza Ali, Plano, TX (US); Fernando A. Mujica, Allen, TX (US)

Correspondence Address: TEXAS INSTRUMENTS INCORPORATED, P O BOX 655474, M/S 3999, DALLAS, TX, 75265

(21) Appl. No.: 09/904,659

(22) Filed: Jul. 16, 2001

Related U.S. Application Data
(60) Provisional application No. 60/251,809, filed on Dec. 7, 2000.

(51) Int. Cl. H04B 1/38; H04L 5/16

(52) U.S. Cl. 375/222

(57) ABSTRACT

A modem operating in a narrow voltage range while maintaining a high signal to noise ratio during reception. The modem may contain a coder-decoder (CODEC) and a transformer. The CODEC receives data using more windings of a primary coil than the number of windings used for transmitting. As a result, the turns ratio is higher during transmission, leading to a correspondingly high amplification during transmission. The high amplification in the transmit direction enables the modem to operate in a narrow voltage range. As more windings of the primary coil are used for receiving, a signal of interest received from the telephone line is attenuated to a corresponding lesser degree, which leads to a high signal to noise ratio.

### RELATED APPLICATION(S)

The present application is related to and claims priority from the co-pending U.S. Provisional Patent Application Serial No. 60/251,809, entitled, “Transformer”, filed on Dec. 7, 2000, and is incorporated in its entirety herewith.

### BACKGROUND OF THE INVENTION

1. Field of the Invention

The present invention relates to modems used in digital subscriber's loop (DSL) environments, and more specifically to a method and apparatus for improving the reception of data in a modem.

2. Related Art

Digital subscriber loop (DSL) technology is generally used to transmit and receive (“tranceives”) data at high bit rates as is well known in the relevant arts. In a typical DSL environment, a modem at one end sends data on a telephone line and another modem at another end receives the data. The data transfer happens in the reverse direction also. The same telephone line is used for both transmission and reception of the data.

Modems typically contain a transformer which is used to tranceive data. Transformers generally contain a primary coil (“primary”) and a secondary coil (“secondary”) and each coil contains multiple windings. The ratio of the number of windings in the secondary to the number of windings in the primary is known as turns ratio.

The strength of the signal generated by a transformer is directly proportional to the turns ratio. For example, assuming that the number of windings on the primary is ‘m’ and the number of windings in the secondary is ‘n’, the turns ratio is n/m. When the transformer transmits a signal is stepped up/down by ‘n/m’ and when receiving the signal is stepped up/down by ‘m/n’.

In one prior approach commonly referred to as a single winding transformer based approach, a secondary contains more windings than a primary and the same windings of the primary are used for both transmitting and receiving. In such a situation, the signal transmitted to a telephone line is stepped up by turns ratio and a signal received from the telephone line is stepped down by the same ratio.

One advantage of the single winding transformer approach is that the components of the a modem can operate in a narrow voltage range (swing). Narrow voltage ranges typically imply that the modems can operate using power supplies of correspondingly lower voltages, which generally leads to lower total implementation costs. However, the step down of the signal received from the telephone line may lead to several disadvantages. For example, the signal to noise ratio may be reduced in proportionate to the step-down factor, and low signal to noise ratio is often undesirable generally because the signal of interest is a correspondingly small fraction of the received signal.

A low signal to noise ratio is particularly problematic in environments in which data is encoded at high rates in a signal received on a telephone line. For example, in remote locations (e.g., homes) implementing ADSL (Asymmetric DSL) technology, the receive bit rate (downstream direction) is much higher than the transmit bit rate (upstream direction), and it may be particularly necessary to maintain a high signal to noise ratio while recovering the data bits from the analog signal received on the telephone line.

Therefore, what is needed is a method and apparatus which enables the signal to noise ratio to be maintained high while enabling modem to operate within a narrow voltage range.

### SUMMARY OF THE INVENTION

A modem provided in accordance with the present invention receives and transmits data on a telephone line while maintaining a high signal to noise ratio and operating within a narrow voltage range. Such a result may be obtained by using more turns (of a primary coil of a transformer) for receiving than for transmitting as described below.

A coder-decoder (CODEC) contained in the modem may convert digital transmit data to an analog transmit signal and transmit the analog transmit signals using a first set of windings. The CODEC may receive an analog receive signal on a second set of windings and convert the analog receive signal to a digital receive data. The first set of windings and the second set of windings may be contained in a primary coil of transformer, and the first set of windings contain a fewer number of windings than the second set of windings. In an embodiment, a subset of the second set of windings are used as the first set of windings.

In one implementation, the CODEC contains a network transmitting the analog transmit signal using the subset of windings. The network further generates a subtraction component representing an echo voltage generated by transmitting the analog transmit signal. An echo cancellation unit subtracts the subtraction component from the analog receive signal to generate a signal of interest representing data received on the telephone line.

An analog to digital converter (ADC) generates the digital receive data from the signal of interest. A digital signal processor (DSP) performs signal processing operation on the digital receive data to recover the data encoded on a signal received on the telephone line. The modem may also include a digital to analog converter (DAC) to convert the digital transmit data to the analog transmit signal.

An embodiment of the network includes multiple impedances, with the subtraction component being measured across one of the impedances. The echo cancellation unit may contain a differential amplifier and multiple resistors. The differential amplifier subtracts the subtraction component from the analog receive signal to generate the signal representing the data received (or transmitted at the other end) on the telephone line.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings, wherein:

FIG. 1 is a block diagram illustrating the details of a DSL modem in accordance with the present invention;

FIG. 2 is a block diagram illustrating the details of an embodiment of a CODEC in accordance with the present invention;

FIG. 3 is a block diagram illustrating the details n embodiment of a hybrid network and an echo cancellation unit;

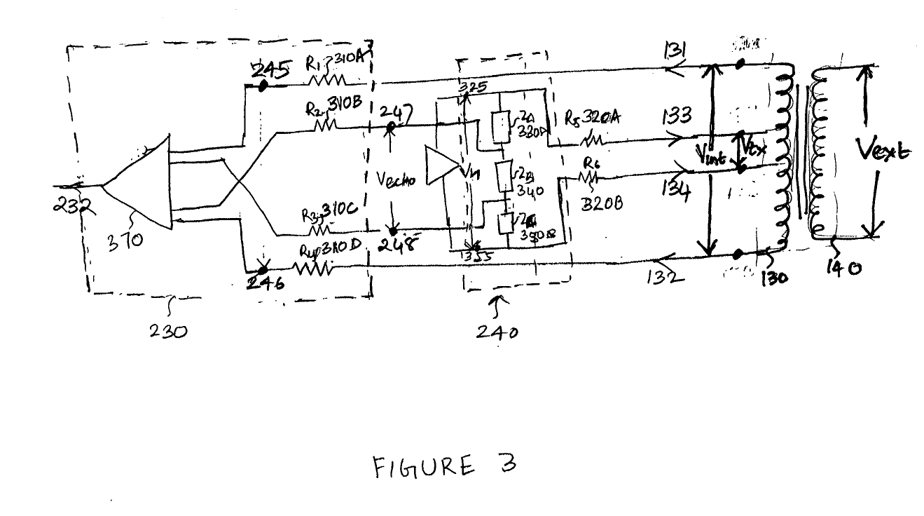

FIG. 4 is a block diagram illustrating the details of an embodiment of hybrid network; and

FIG. 5 is a block diagram illustrating an example environment in which the present invention can be implemented.

### DETAILED DESCRIPTION OF THE PREFERRED EMBODIMENTS

1. Overview and Discussion of the Invention

The present invention enables a modem to maintain a high signal to noise ratio while operating within a narrow voltage range. The features are achieved by using a multi-winding transformer approach, in which the data is received on several windings of a primary, but transmission is performed using only a subset of the same windings. By using more windings in the receive direction, the attenuation of a signal received from a telephone line is minimized, thereby potentially increasing the signal to noise ratio. By using less windings (of a primary) in the transmit direction, the modem operates in a low voltage range.

Several aspects of the invention are described below with reference to example environments for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Modem

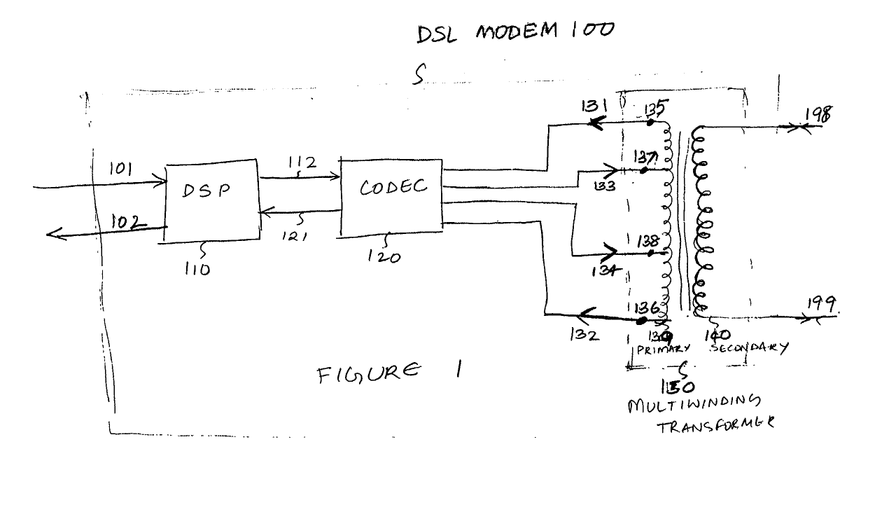

FIG. 1 is a block diagram illustrating a DSL modem in which the present invention can be implemented. There is shown DSL modem 100 containing digital signal processor (DSP) 110, coder-decoder (CODEC) 120 and multi-winding transformer 150. Each component is described below in further detail.

DSP 110 performs operations such as frequency transformation on the stream of data bits received on input paths 101 and 121, and generates a corresponding stream of data bits on output paths 112 and 102 respectively. DSP 110 may be implemented in a known way.

Transformer 150 is shown containing primary coil 130 and secondary coil 140, each in turn containing multiple windings. Secondary coil 140 is connected to telephone line pair (198 and 199) over which transmission and reception of data occurs. Primary coil 130 is shown containing transmit tap pair 137 and 138 and receive tap pair 135 and 136. As may be readily observed, receive tap pair (135 and 136) contains all the windings of primary 130, and transmit tap pair (137 and 138) contains only a subset of the windings. The manner in which the tap pairs are used is described below in further detail.

According to an aspect of the present invention, CODEC 120 transmits analog transmit signal using transmit tap pair 137/138, and receives analog receive signal using receive tap pair 135/136. By using less windings in the transmit direction, CODEC 120 may be implemented to operate at a lower voltage range for a desired strength of the signal on secondary 140 during transmission. By using more windings for reception, a signal of interest received on telephone wire pair 198/199 is amplified to a desired high degree.

The analog transmit signals transmitted on path 133/134 are generated based on the digital transmit data present on path 112. In addition, CODEC 120 converts the analog receive signal received from transformer 150 (on path 131 and 132) into digital receive data for transmission on path 121.

The analog receive signal received on path 131/132 contains an echo voltage corresponding to the analog transmit signal transmitted on path 137/138. CODEC 120 operates to eliminate the echo voltage from the analog receive signal as described below in further detail.

3. CODEC

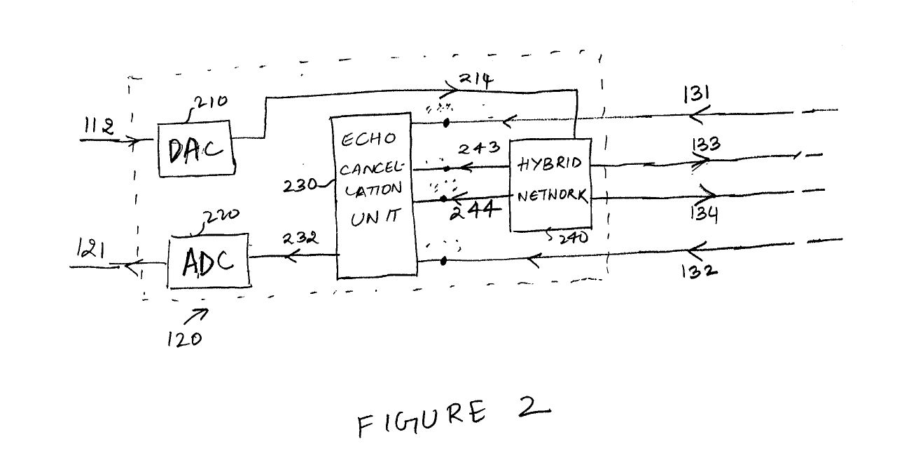

FIG. 2 is a block diagram illustrating the details of CODEC 120 in one embodiment. CODEC 120 is shown containing digital to analog converter (DAC) 210, analog to digital converter (DAC) 220, echo cancellation unit 230 and hybrid network 240. Each component is explained in further detail below.

DAC 210 converts digital transmit data (received on path 112) into analog form. The analog equivalent of the digital transmit data is provided as input (on path 214) to hybrid network 240. ADC 220 converts analog signals received on path 232 into digital format, and transmits the resulting data on path 121. DAC 210 and ADC 220 may be implemented in a known way.

Hybrid network 240 transmits analog transmit signal (path 214) on path 133/134. Hybrid network 240 may also generate an echo voltage (on path 243 and 244) proportionate to an echo component present on the analog receive signal caused due to the strength analog transmit signal transmitted on path 134/134. As described below, the echo voltage is used to cancel echo component present in the analog receive signal received on path 131/132.

Echo cancellation unit 230 subtracts the echo voltage (received on path 243 and 244) from the analog receive signal received on receive path 131/132 and generates a corresponding analog signal on path 232. The analog signal contains data encoded in a signal of interest received on secondary 140, and thus the data is recovered when sampled by ADC 220. The description is continued with reference to an example embodiment of hybrid network 240 and echo cancellation unit 230.

4. Hybrid Network and Echo Cancellation Unit

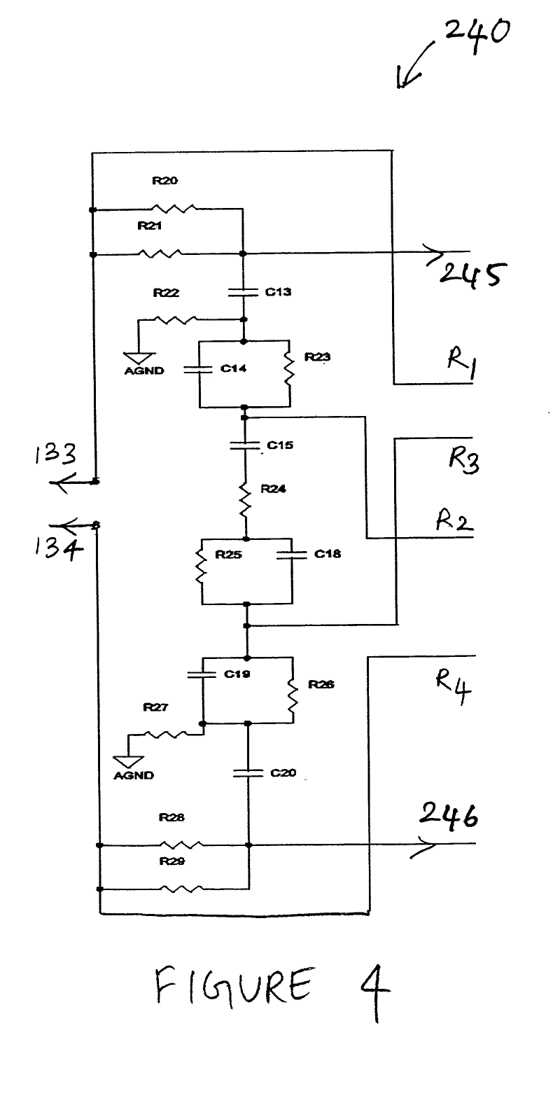

FIG. 4 is a block diagram illustrating the details of hybrid network 240 and echo cancellation unit 230 in one embodiment. Hybrid network 240 is shown containing impedances 330A (“ZA”), 340 (“ZB”) and 330B (“ZC”) connected in series. Resistors 320A (“R6”) and 320B (“R6”) are connected to impedances ZA and ZC respectively. Echo cancellation unit 230 is shown containing a differential amplifier 370 and four resistors 310A (“R1”), 310B (“R2”), 310C (“R3”) and 310D (“R4”).

Vint represents the analog receive signal voltage containing the noise components (including echo component) and exists between nodes 131 and 132. Vtx represents the analog transmit signal voltage between nodes 133 and 134 and is transmitted by transformer 150. Vext represents the voltage that is received at secondary 140 of transformer 150. Voltage across nodes 325 and 355 is represented by Vh and Vecho represents the voltage across ZB.

In an embodiment, hybrid network 240 contains three impedances ZA, ZB, ZC connected in series and may be implemented to generate an echo voltage. Echo voltage Vecho is measured across ZB.

Echo voltage Vecho and internal voltage Vint are provided as inputs to differential amplifier 370. Differential amplifier 370 subtracts echo voltage Vecho from internal received voltage Vint to generate output Vext which may approximately equal the voltage received at secondary 140.

The manner in which the impedances 330, 340 and 350 are designed is described in detail below.

Vtx may mathematically be represented as

Vtx=Vh*ZL/(ZL+2R5) Equation (1)

wherein Vtx represents the analog transmit signal voltage transmitted, Vh represents the voltage across hybrid network 240 (i.e., between nodes 133 and 134), ZL represents the impedance of the portion of primary between the transmit tap pair 133, 134; R5 represents the resistance 320A, and “*” represents multiplication operation.

The voltage Vint between nodes 131 and 132 equals sum of the voltage received Vext by secondary 140 and noise components that are introduced due to transmitted voltage Vtx. Thus, Vint may be represented as

Vint=Vext+Vtx Equation (2)

The voltage Vecho between nodes 247 and 248 may be mathematically represented as:

Vecho=Vh*ZB/(ZB+ZA+ZC) Equation (3)

wherein ZA represents impedance 330A, ZB represents impedance 340 and ZC represents impedance 330B.

The output Vext generated by differential amplifier 370 is Vecho subtracted from Vint. Thus

Vext=Vint−Vecho Equation (4)

On substituting Equation (2) in Equation (4) VRX may be represented as

Vext=Vext+Vtx−Vecho Equation (5)

Vext=Vext+Vh*ZL/(ZL+2R5)−Vh*ZB/(ZB+ZA+ZC) Equation (6)

Equation (6) can be balanced when the coefficients of Vh are equated with each other.

ZL/(ZL+2R5)=ZB/(ZB+ZA+ZC) Equation (7)

Thus, the impedances of hybrid network 240 can be designed according to equation (7). The description is continued with reference to an embodiment of hybrid network 240 designed according to Equation (7).

5. Embodiment of Hybrid Network

FIG. 4 illustrates the details of an embodiment of hybrid network 240. Hybrid network 240 is shown containing resistors R20 through R29 and capacitors C13 through C15 and C18 through C20. R23 and C14 represent impedance ZA, R25 and C18 represent ZB and R26 and C19 represent ZC. The values corresponding to each component is described below.

R22, R23, R24, R25 and R26 have values of 121, 169, 464, 2430 and 121 ohms respectively. C13 and C20 have a value of 0.247 micro farad, C14 and C19 have a value of 50 pico farads, C15 is of 5600 pico farads and C18 is of 0.15 micro farads. R20 and R28 are of 732 ohms each and R21 and R29 have a value of 1391 ohms.

The description is continued with reference to an example environment where DSL modem 100 may be implemented.

6. Example Environment

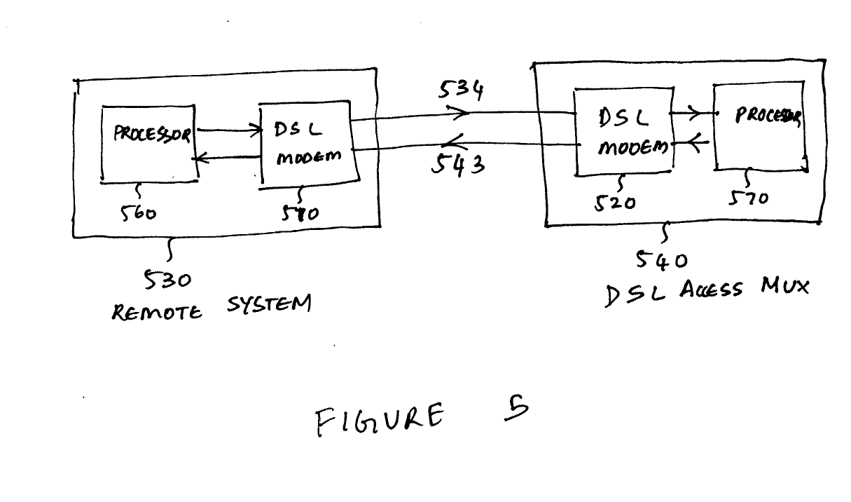

FIG. 5 is a block diagram illustrating an example environment in which the present invention can be implemented. There is shown remote system 530 and DSL Access Multiplexor (DSLAM) 540, which are examples of systems using a modem implemented in accordance with the present invention. Remote systems are typically present in locations such as homes which are connected to a central office using telephone wires. DSLAMs are present in the central offices. Each component is described below in further detail.

Remote system 530 is shown containing processor 560 and DSL modem 510. Processor 560 performs various operations on digital data which may have to be transmitted. DSL modem 510 transmits digital data by converting digital data into analog form and transmitting over a telephone line as described above.

Similarly, DSL modem 510 converts analog signals received over telephone line (534, 543) into digital format before providing the data to processor 560. The analog data is transmitted to and received from central exchange 540 on paths 534 and 543.

DSLAM 540 is shown containing DSL modem 520 and DSL MUX 570. DSL modem receives analog signals over a telephone line and converts the signals into digital format. DSL MUX 570 receives and transmits digital data to various others systems (potentially using routers and/or switches, not shown) that are connected to central exchange 540. DSL modems 510 and 520 may correspond to modem 100 of FIG. 1.

In an embodiment, DSL modem 520 can be implemented in an asymmetric digital subscriber's loop (ADSL) technology. As is well known in the relevant arts, ADSL technologies enable the user to receive data at a faster rate (downstream rate). A high signal to noise ratio is desired when data is received at a fast rate. Thus, the present invention is particularly useful in implementing modem 510 in ADSL environment.

Thus, the embodiments described above can be used to improve reception of data in DSL modems. The present invention enables a modem to operate within a narrow voltage range while maintaining a high signal to noise ratio.

7. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A modem for receiving and transmitting data on a telephone line, said modem comprising:
a transformer having a primary coil and a secondary coil, said primary coil having a plurality of windings, said secondary coil being connected to said telephone line; and
a coder-decoder (CODEC) converting a digital transmit data to an analog transmit signal and transmitting said analog transmit signals using a first set of windings, said CODEC receiving an analog receive signal on a second set of windings and converting said analog receive signal to a digital receive data, said first set of windings and said second set of windings being contained in said plurality of windings, said first set of windings containing a fewer number of windings than said second set of windings.

2. The modem of claim 1, wherein said second set of windings comprises said plurality of windings and said first set of windings comprises a subset of said plurality of windings.

3. The modem of claim 2, further comprising a digital signal processor (DSP) performing signal processing operation on said digital receive data to recover the data encoded on a signal received on said telephone line.

4. The modem of claim 2, wherein said CODEC comprises:
a network transmitting said analog transmit signal using said subset of windings, said network generating a subtraction component representing an echo voltage generated by transmitting said analog transmit signal;
an echo cancellation unit receiving said analog receive signal present on said plurality of windings and subtracting said subtraction component from said analog receive signal to generate a signal of interest representing data received on said telephone line;
an analog to digital converter (ADC) generating said digital receive data from said signal of interest, wherein said DSP is coupled to receive said digital receive data generated by said ADC; and
a digital to analog converter (DAC) converting said digital transmit data to said analog transmit signal.

5. The modem of claim 4, wherein said network comprises a plurality of impedances, wherein said subtraction component is measured across one of said plurality of impedances.

6. The modem of claim 4, wherein said echo cancellation unit comprises a differential amplifier and a plurality of resistors, wherein said differential amplifier subtracts said subtraction component from said analog receive signal to generate said signal representing said data transmitted on said telephone line.

7. The modem of claim 1, wherein said plurality of windings comprise all windings present in said primary coil.

8. A modem for receiving and transmitting data on a telephone line, said modem comprising:
means for converting a digital transmit data to an analog transmit signal;
means for transmitting said analog transmit signal using a first set of windings of a primary coil of a transformer; and
means for receiving an analog receive signal using a second set of windings of said primary coil, wherein said first set of windings and said second set of windings are contained in said plurality of windings, said first set of windings containing a fewer number of windings than said second set of windings.

9. The modem of claim 8, further comprising:
means for generating a subtraction component representing an echo voltage generated by said transmitting; and
means for subtracting said subtraction component from said analog receive signal to generate a signal of interest representing data received on said telephone line.

10. The modem of claim 9, wherein said second set of windings comprises said plurality of windings and said first set of windings comprises a subset of said plurality of windings.

11. A system comprising:
a processor sending a digital transmit data and receiving a digital receive data; and
a modem sending said digital transmit data on a telephone line, said modem generating said digital receive data based on a signal of interest received on said telephone line, said modem comprising:
a transformer having a primary coil and a secondary coil, said primary coil having a plurality of windings, said secondary coil being connected to said telephone line; and
a coder-decoder (CODEC) converting said digital transmit data to an analog transmit signal and transmitting said analog transmit signals using a first set of windings, said CODEC receiving an analog receive signal on a second set of windings and converting said analog receive signal to a digital receive data, said first set of windings and said second set of windings being contained in said plurality of windings, said first set of windings containing a fewer number of windings than said second set of windings.

12. The system of claim 11, wherein said second set of windings comprises said plurality of windings and said first set of windings comprises a subset of said plurality of windings.

13. The system of claim 12, further comprising a digital signal processor (DSP) performing signal processing operation on said digital receive data to recover the data encoded on a signal received on said telephone line.

14. The system of claim 12, wherein said CODEC comprises:
a network transmitting said analog transmit signal using said subset of windings, said network generating a subtraction component representing an echo voltage generated by transmitting said analog transmit signal;
an echo cancellation unit receiving said analog receive signal present on said plurality of windings and subtracting said subtraction component from said analog receive signal to generate a signal of interest representing data received on said telephone line;
an analog to digital converter (ADC) generating said digital receive data from said signal of interest, wherein said DSP is coupled to receive said digital receive data generated by said ADC; and
a digital to analog converter (DAC) converting said digital transmit data to said analog transmit signal.

15. The system of claim 14, wherein said network comprises a plurality of impedances, wherein said subtraction component is measured across one of said plurality of impedances.

16. The system of claim 14, wherein said echo cancellation unit comprises a differential amplifier and a plurality of resistors, wherein said differential amplifier subtracts said subtraction component from said analog receive signal to generate said signal representing said data transmitted on said telephone line.

17. The system of claim 11, wherein said plurality of windings comprise all windings present in said primary coil.

18. The system of claim 11, wherein said modem is implemented according to digital subscriber loop (DSL) technology.

19. The system of claim 18, wherein said modem is implemented according to asymmetric DSL technology.

20. A method of for transmitting and receiving data on a telephone line, said method comprising:
converting a digital transmit data to an analog transmit signal;
transmitting said analog transmit signal using a first set of windings of a primary coil of a transformer; and
receiving an analog receive signal using a second set of windings of said primary coil, wherein said first set of windings and said second set of windings are contained in said plurality of windings, said first set of windings containing a fewer number of windings than said second set of windings.

21. The method of claim 20, further comprising:
generating a subtraction component representing an echo voltage generated by said transmitting; and
subtracting said subtraction component from said analog receive signal to generate a signal of interest representing data received on said telephone line.

22. The method of claim 21, wherein said second set of windings comprises said plurality of windings and said first set of windings comprises a subset of said plurality of windings.
